(19) United States
(12) Patent Application Publication
(10) Pub. No.: US 2014/0299554 A1
(43) Pub. Date: Oct. 9, 2014

(54) Wastewater Treatment System and Method

(71) Applicant: Britenstine Incorporated, Sunbury, OH (US)

(72) Inventor: Eric A. Britenstine, Sunbury, OH (US)

(73) Assignee: BRITENSTINE INCORPORATED, Sunbury, OH (US)

(21) Appl. No.: 14/307,819

(22) Filed: Jun. 18, 2014

Related U.S. Application Data
(63) Continuation-in-part of application No. 13/014,698, filed on Jan. 26, 2011, now Pat. No. 8,758,630.

(51) Int. Cl. C02F 1/32; C02F 1/76

(52) U.S. Cl. CPC C02F 1/325; C02F 1/76
USPC 210/748.11; 210/198.1; 250/438

(57) ABSTRACT

Disclosed is a treatment unit for treating wastewater that includes a treatment housing having a wastewater inlet and a treated water outlet; a vertical turbulator plate located in the vicinity of the wastewater inlet; a vertical ultraviolet (UV) tube assembly located between the turbulator plate and the treated water outlet; and an electrical controller. The turbulator plate has different size apertures. The treatment unit also can include a flow paddle located in the wastewater inlet, a paddle flow controller that actuates the flow paddle, and an electrical controller supplies power to the UV tube assembly and to the paddle flow controller. The corresponding method for treating wastewater with the treatment unit also is disclosed.

### CROSS-REFERENCE TO RELATED APPLICATIONS

This application claims benefit of application Ser. No. 13/014,698 filed Jan. 26, 2011, now U.S. Pat. No. 8,758,630, which in turn claims benefit of priority of provisional application Ser. No. 61/361,372 filed Jul. 2, 2010.

### STATEMENT REGARDING FEDERALLY SPONSORED RESEARCH

Not applicable.

### BACKGROUND

The present disclosure relates to treatment of waste streams for reduction of, for example, fecal coliforms or e. coli, and more particularly to an ultraviolet (UV) treatment apparatus and method of its use.

Typical treatment of such waste streams involves use of chlorine to kill the bacteria. Sodium thiosulfate or the like needs to be added to remove chlorine post treatment; however, this lowers the oxygen levels. Additional chemicals and lower oxygen levels in receiving waters are not an ideal final result. Thus, in application Ser. No. 13/014,698, now U.S. Pat. No. 8,758,630, an apparatus and method using UV treatment for bacteria eradication is disclosed. A unique baffle chamber construction permitted sufficient treatment time for the UV irradiation (e.g., 254 nm range) to accomplish the fecal coliform and/or e. coli treatment. The present disclosure expands upon and refines such UV chamber construction and method.

### BRIEF SUMMARY

Disclosed is a treatment unit for treating wastewater that includes a treatment housing having a wastewater inlet and a treated water outlet; a vertical turbulator plate located in the vicinity of the wastewater inlet; a vertical ultraviolet (UV) tube assembly located between the turbulator plate and the treated water outlet; and an electrical controller. The turbulator plate has apertures of different size to create turbulence. The treatment unit also can include a flow paddle located in the wastewater inlet, a paddle flow controller that actuates the flow paddle, and an electrical controller supplies power to the UV tube assembly and to the paddle flow controller. The corresponding method for treating wastewater with the treatment unit also is disclosed.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is an isometric view of the disclosed wastewater treatment unit;

FIG. 2 is a sectional view taken along line 2-2 of FIG. 1;

FIG. 3 is an isometric view of the disclosed wastewater treatment until with the lid removed;

FIG. 4 is an electrical schematic for the disclosed wastewater treatment unit; and

FIG. 5 is an isometric view of the disclosed wastewater treatment unit sitting atop a chlorine tank.

The drawings will be described in greater detail below.

### DETAILED DESCRIPTION

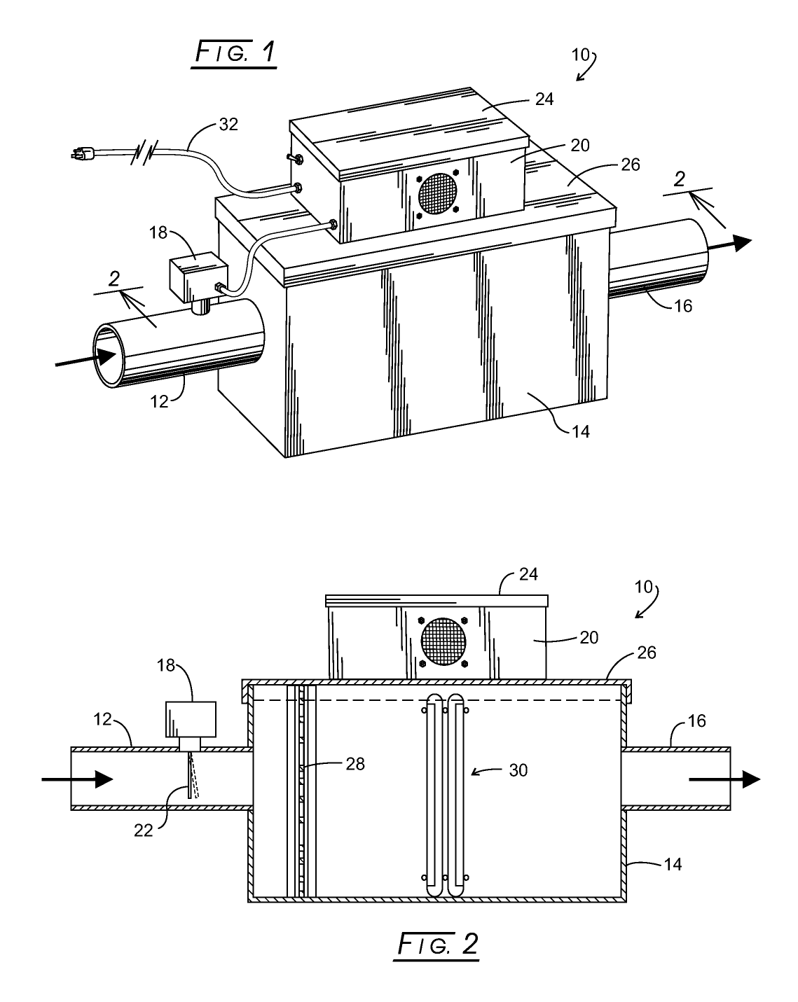

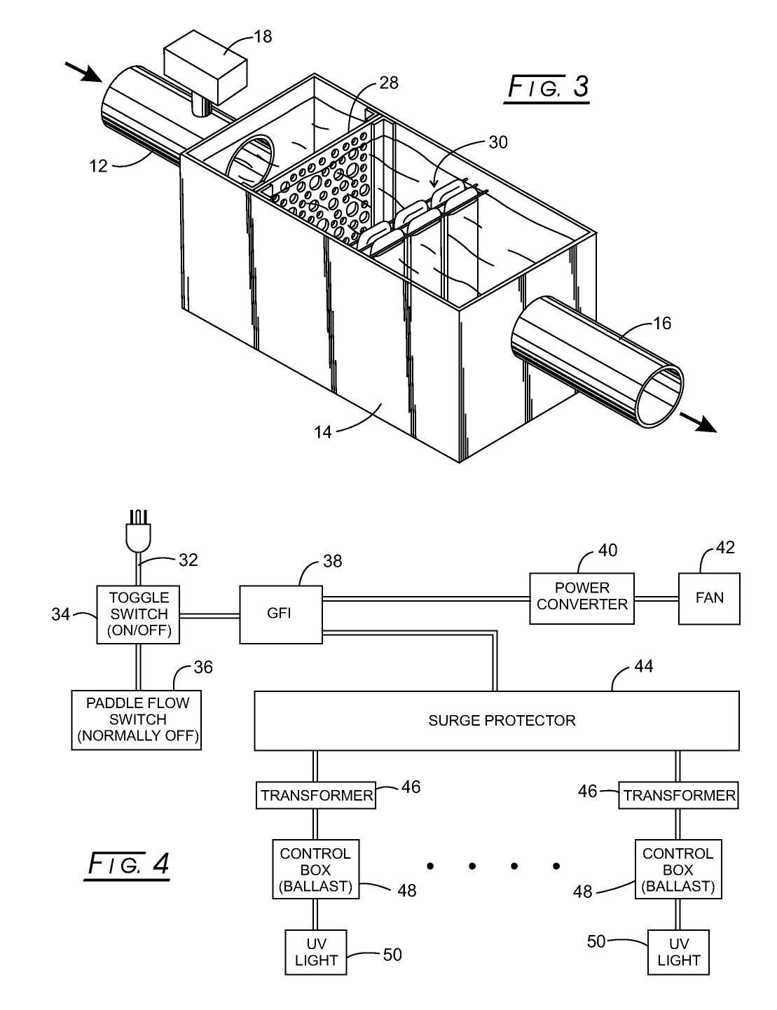

The basic components of the disclosed, self-contained wastewater treatment unit, 10, are seen in FIGS. 1 and 2, and include, inter alia, a wastewater inlet pipe, 12, treatment housing, 14, outlet pipe, 16, paddle flow switch, 18, and electrical control box, 20. Wastewater flows into unit 10 via inlet pipe 12 through housing 14 where it resides for a time sufficient for ultra violet (UV) treatment to be effected and is withdrawn from housing 14 for disposal and/or further treatment, such as, for example, additional such units.

The disclosed treatment until is readily able to produce an effluent that meets the regulations set for in the Federal Water Pollution Control Act, as amended (33 U.S.C. 1251, et. seq.) and the Ohio Water Pollution Control Act (Ohio Revised Code Section 6111)—discharge permit. In particular, the improved design of the disclosed until retards build up of fecal matter on flat and inclined surfaces. The disclosed unit produces a high quality effluent having at least 65% UV transmittance at 254 nanometers wavelength, and BOD and suspended solids concentrations no greater than 30 mg/L at any time. BOD or biochemical oxygen demand is the amount of dissolved oxygen needed by aerobic biological organisms in a body of water to break down organic material present in a given water sample at certain temperature over a specific time period. The term also refers to a chemical procedure for determining this amount. This is not a precise quantitative test, although it is widely used as an indication of the organic quality of water. The BOD value is most commonly expressed in milligrams of oxygen consumed per liter of sample during 5 days of incubation at 20° C. and is often used as a robust surrogate of the degree of organic pollution of water.

The disclosed wastewater treatment unit is designed to handle between about 5 and 20 gallons/minute of wastewater, depending upon the quality of the feed wastewater. The unit is nominally about 16″×13″×18″ in dimension; although it certainly could be built larger in size. Feed wastewater typically flows from sand filters or other tertiary treatment into inlet pipe 12 triggering a flow paddle, 22, to turn on a paddle flow switch, 18. This, in turn, turns on wastewater treatment unit 10, as the unit is normally off. When inlet flow stops, paddle flow switch 18 returns to an off position. Flow rate is controlled externally by a gate valve in the discharge line from a submerged pump (described later) or by gravity feed rate into inlet pipe 54 (not seen in the drawings). The flow rate of wastewater admitted into treatment housing 14 is based on the capacity of housing 14 and the time of UV treatment required to reach the desired purity of water discharged.

Electrical box has a lid, 24, for gaining access into it. Treatment housing 14 has a lid, 26, for gaining access into it. The water level inside housing 14 is shown in phantom. A turbulator plate, 28, is located after the wastewater enters into treatment housing 14. Turbulator plate 28 is a vertical perforated plate. Turbulator plate will cause turbulence or roil in the flow of water passing through treatment housing 14 by dint of the holes or perforations in it, typically ranging in size from as small as about ½ to about ¾ inches in diameter to as large as about 3 inches. The turbulence is caused by dint of turbulator plate 28 having different sized holes in the range disclosed.

The effectiveness of the turbulator plate was revealed in testing of the disclosed unit without the turbulator plate on wastewater with a substantially higher fecal count than is found in typical use. In this control, the treated water fecal count was about 30,000. With the addition of a turbulator plate being 12″×14″ and having ¾ inch and 2 ½ inch apertures in it (2 rows with large-small-large across the top and small-large-small across the bottom), the counts were reduced to around 9,000 or a 70% reduction. It should be noted that the wastewater used had a substantially higher fecal count than is typically encountered for wastewater fed to the disclosed treatment unit. Nevertheless, the affect of the turbulator plate was demonstrated.

Treatment of the wastewater within treatment housing 14 is effected by a series of UV lamps disposed in the roiling water. A UV lamp assembly, 30, is seen in FIG. 2. There are 6 UV lamp assemblies, 3 facing inlet pipe 12 and 3 facing outlet pipe 14. A wire rack is used to hold each UV lamp and to provide support for each UV lamp. The UV lamps are in electrical connection with and controlled by electrical control box 20. UV dosage typically will be not less than about 30 K μW cm² after adjustments for maximum tube fouling, lamp output reduction after 8,760 hours of operation and other energy losses. An alarm system is provided in electrical control box 20 to separately indicate lamp failure and low UV intensity.

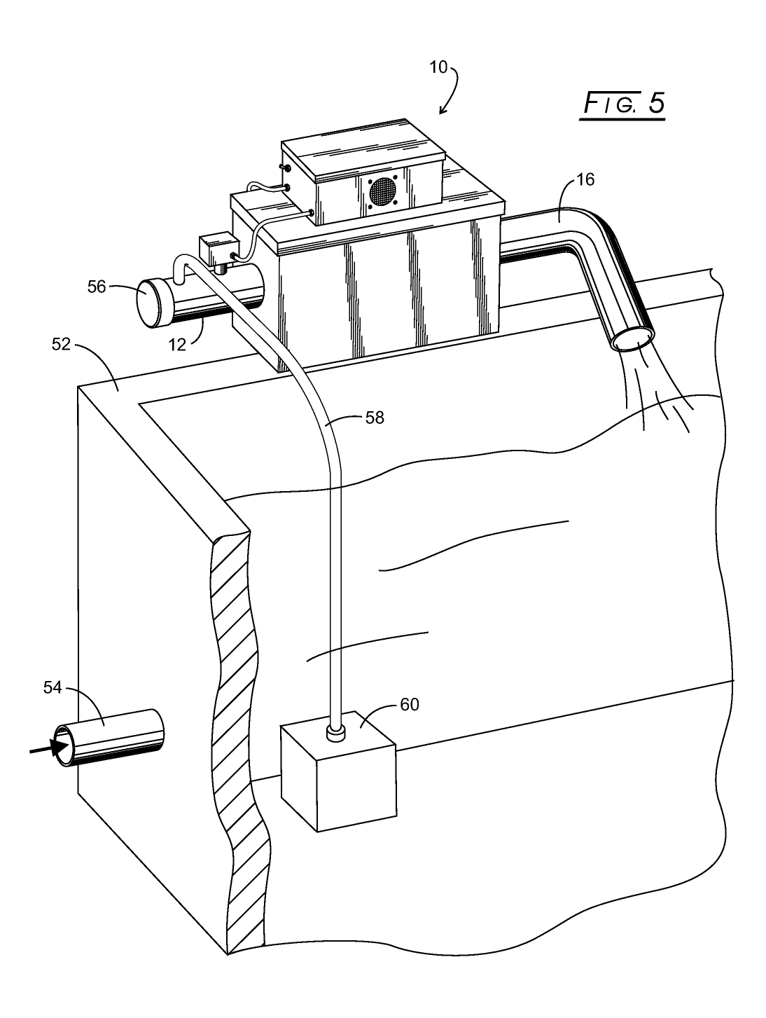

Referring now to electrical control box 20 in more detail, reference is made to FIG. 4. Electrical power is supplied by electric cord, 32, which plugs into any 110V outlet. An on/off toggle switch, 34, is accessed on the outside of electrical control box 20 (see FIG. 1). A paddle flow switch, 36, is in the normally off position and turns on when wastewater flows into flow paddle 22, as described above. From toggle switch 34, the line power runs through a ground fault interrupt (GFI), 38, and then to a power converter, 40, that runs to a fan, 42, for cooling all the electrical components housed with electrical control box 20. It should be noted that a screen-covered apertures, 43, is located on one side of electrical control box with a similar such screen-covered aperture located on the opposite side not shown in the drawings. The line power from GFI 38 also runs to a surge protector, 44, for all of the UV bulbs. In particular, each UV bulb assembly includes a transformer, 46, control box or ballast, 48, and UV bulb, 50. Only two of such UV bulb assemblies are shown in FIG. 4 with the exact number depending upon the number of UV tubes disposed within treatment housing 14.

In situations where it is necessary, desirably, or convenient, wastewater treatment unit 10 can be mounted atop a chlorination tank, 52, as shown in FIG. 5 or inside chlorination tank 52 above the water line. In the design in the drawings, wastewater is admitted into chlorination tank 52 through an inlet pipe, 54. An end cap, 56, is placed on inlet tube 12 of wastewater treatment unit 10. Outlet tube 16 directs the flow of water from wastewater treatment unit 10 into chlorination tank 52. In all other respects, wastewater treatment unit 10 operates in accordance with the foregoing description. Water is admitted into wastewater treatment unit 10 from chlorination tank 54 via an inlet tube, 58, which is connected to wastewater treatment unit 10 inlet tube 12 from a pump, 60, submerged within chlorination tank 52.

Materials of construction will be corrosion resistant and include stainless steel, plastics, plastic coated mild steel or other metal, and like materials. The disclosed wastewater treatment unit can be hooked in cascade, parallel, series, or combinations. Additionally, the disclosed unit can be modified to include specialized cartridges, such as, for example, an activated charcoal cartridge for removal of pharmaceuticals from the wastewater being treated.

While the device and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. A treatment unit for treating wastewater, which comprises:
(a) a treatment housing having a wastewater inlet and a treated water outlet;
(b) a vertical turbulator plate located in the vicinity of the wastewater inlet having different sized apertures;
(c) a vertical ultraviolet (UV) tube assembly located between the turbulator plate and the treated water outlet; and
(d) an electrical controller for the UV tube assembly.

2. The treatment unit of claim 1, wherein a flow paddle is located in the wastewater inlet and a paddle flow controller actuates the flow paddle.

3. The treatment unit of claim 2, wherein the apertures in the turbulator plate range in size from about 0.5 inches to about 3 inches.

4. The treatment unit of claim 1, wherein the turbulator plate extends the full height of wastewater located in the treatment housing.

5. The treatment unit of claim 1, wherein UV tube assembly extends the full height of wastewater located in the treatment housing.

6. The treatment unit of claim 1, wherein the electrical controller is located atop the treatment housing.

7. The treatment unit of claim 1, wherein the electrical controller includes a fan, ground fault interrupt, and a transformer and ballast for said UV tube assembly.

8. The treatment unit of claim 1, wherein said UV tube assembly includes UV tubes directed towards the inlet and UV tubes directed towards the outlet.

9. The treatment unit of claim 1, wherein a chlorinator unit is associated with the treatment unit.

10. The treatment unit of claim 1, which additionally comprises a flow paddle is located in the wastewater inlet and a paddle flow controller actuates the flow paddle and an electrical controller supplies power to the UV tube assembly and to the paddle flow controller.

11. A method for treating wastewater, which comprises the steps of:
(1) providing a treatment unit, which comprises:
(a) a treatment housing having a wastewater inlet and a treated water outlet;
(b) a vertical turbulator plate located in the vicinity of the wastewater inlet;
(c) a vertical ultraviolet (UV) tube assembly located between the turbulator plate and the treated water outlet; and
(d) an electrical controller.
(2) passing wastewater through the water inlet and into the treatment housing:
(3) passing wastewater in the treatment unit through the turbulator plate to roil the wastewater;
(4) exposing the roiled wastewater to ultraviolet (UV) radiation; and
(5) withdrawing UV treated wastewater from the treatment housing via the treated water outlet.

12. The method claim 11, which additionally includes the step of locating a flow paddle in the wastewater inlet and providing a paddle flow controller that actuates the flow paddle.

13. The method of claim 12, which additionally includes the step of providing apertures in the turbulator plate ranging in size from about 0.5 inches to about 3 inches.

14. The method of claim 1, wherein the turbulator plate extends the full height of wastewater located in the treatment housing.

15. The method of claim 11, wherein UV tube assembly extends the full height of wastewater located in the treatment housing.

16. The method of claim 11, wherein the electrical controller is located atop the treatment housing.

17. The method of claim 11, wherein the electrical controller includes a fan, ground fault interrupt, and a transformer and ballast for said UV tube assembly.

18. The method of claim 11, wherein said UV tube assembly includes UV tubes directed towards the inlet and UV tubes directed towards the outlet.

19. The method of claim 11, which additionally includes the step of providing a chlorinator unit in association with the treatment unit.

20. The method of claim 11, which additionally includes the steps of providing a flow paddle located in the wastewater inlet, a paddle flow controller that actuates the flow paddle, and an electrical controller that supplies power to the UV tube assembly and to the paddle flow controller.
